(19) United States
(12) Patent Application Publication
(10) Pub. No.: US 2021/0194368 A1
(43) Pub. Date: Jun. 24, 2021

(54) CONSTANT CURRENT CIRCUIT

(71) Applicant: KABUSHIKI KAISHA TOKAI-RIKA-DENKI-SEISAKUSHO, Aichi-ken (JP)

(72) Inventor: Keigo Kagimoto, Aichi-ken (JP)

(73) Assignee: KABUSHIKI KAISHA TOKAI-RIKA-DENKI-SEISAKUSHO

(21) Appl. No.: 17/128,283

(22) Filed: Dec. 21, 2020

(30) Foreign Application Priority Data
Dec. 23, 2019 (JP) 2019-231939

(51) Int. Cl. H02M 3/158; H02M 1/088

(52) U.S. Cl. CPC H02M 3/158; H02M 1/088

(57) ABSTRACT

A constant current circuit is provided including: a constant current generation circuit; a control transistor included in the constant current generation circuit and configured to flow with a constant current generated by the constant current generation circuit and with a start-up current at start-up; an output transistor having a gate voltage controlled by the control transistor and configured to generate an output current based on the constant current; and a bypass transistor having a gate with common connection to a gate of the control transistor and configured to cause the start-up current flowing in the control transistor to bypass after start-up.

### CROSS-REFERENCE TO RELATED APPLICATION

This application is based on and claims priority under 35 USC 119 from Japanese Patent Application No. 2019-231939 filed on Dec. 23, 2019, the disclosure of which is incorporated by reference herein.

### BACKGROUND

### Technical Field

The present disclosure relates to a constant current circuit.

As an example of related art relating to a start-up circuit of a constant current circuit, Japanese Patent Application Laid-Open (JP-A) No. H02-214911 discloses a start-up circuit of an integrated circuit. The integrated circuit disclosed in JP-A No. H02-214911 includes a first circuit of a pair of transistors with commonly connected bases and a second circuit of a pair of transistors with commonly connected bases, with the first circuit and the second circuit connected to each other in a cascade so as to apply a mutual bias to each other, and includes a transistor to start up the first circuit and the second circuit. In the start-up circuit of this integrated circuit, a capacitor is connected to the start-up transistor so as to form capacitive load in the start-up circuit.

FIG. 3A illustrates a constant current circuit 100 provided with a start-up circuit similar to the start-up circuit disclosed in JP-A No. H02-214911. As illustrated in FIG. 3A, the constant current circuit 100 includes N-type metal oxide semiconductor (MOS) transistors QN11, QN12, P-type MOS transistors QP11, QP12, QP13, and resistors R11, R12. The constant current circuit 100 is a current mirror-type constant current circuit, in which a mirror source constant current It flowing in the P-type MOS transistor QP12 is mirrored in a constant current that flows in the P-type MOS transistor QP13 to generate an output current Iout. The output current Iout is a constant current that the constant current circuit 100 is intended to generate. In the constant current circuit 100, the resistor R12 configures a start-up circuit of the constant current circuit 100. When a power source VBB is switched on, a start-up current Iw flows in the resistor R12, thus starting up the constant current circuit 100. Note that the letters GND in FIG. 3A refer to ground (earth).

However, it is important to note that since the current flowing in the P-type MOS transistor QP12 is (It+Iw), the output current Iout of the constant current circuit 100 is not Iout=It, but rather Iout=(It+Iw). FIG. 3B illustrates power source voltage dependencies of the constant current It, the start-up current Iw, and the output current Iout accompanying start-up of the power source VBB. The constant current It is determined by the transistor size of a current mirror circuit and the resistance value of the resistor R11, and as illustrated in FIG. 3B, the constant current It initially rises accompanying a rise in the power source voltage, before converging at a substantially constant value.

By contrast, if the potential difference between the source and drain of the P-type MOS transistor QP12 is denoted Vds, the start-up current Iw corresponds to (VBB−Vds)/R12, and so is dependent on the power source. Note that VBB is the voltage of the power source VBB, and R12 is the resistance value of the resistor R12. Accordingly, the start-up current Iw also rises accompanying the rise in the power source voltage, and the start-up current Iw that has thus risen is added to the output current Iout. Accordingly, as illustrated in FIG. 3B, the output current Iout also rises accompanying a rise in the power source voltage. Since the constant current It is the intended output current of the constant current circuit 100, the start-up current Iw becomes an error component. Namely, although the start-up current Iw is required when starting up the constant current circuit 100, it is no longer necessary after the constant current circuit 100 has started up. The precision of the output current Iout suffers due to the start-up current Iw continually flowing.

### SUMMARY

In consideration of the above circumstances, exemplary embodiments of the present disclosure relate to providing a constant current circuit capable of improving the precision of an output current.

A constant current circuit according to a first aspect of the present disclosure includes: a constant current generation circuit; a control transistor included in the constant current generation circuit and configured to allow a constant current generated by the constant current generation circuit and a start-up current at start-up to flow; an output transistor having a gate voltage controlled by the control transistor and configured to generate an output current based on the constant current; and a bypass transistor having a gate with common connection to a gate of the control transistor and configured to cause the start-up current flowing in the control transistor to bypass after start-up.

In the constant current circuit according to the first aspect, the bypass transistor having a gate with common connection to a gate of the control transistor causes the start-up current flowing in the control transistor to bypass after start-up. Thus, the constant current circuit according to the first aspect enables the precision of the output current to be improved.

In a constant current circuit according to a second aspect of the present disclosure, the constant current generation circuit is a current mirror circuit configured including a first transistor of a first conductivity type and having a gate and a drain connected together, a second transistor of the first conductivity type and having a gate connected to the gate of the first transistor and a source connected to a first resistor, and a third transistor of a second conductivity type having a drain connected to the drain of the first transistor. The control transistor is of the second conductivity type and has a gate and a drain connected together, and a drain of the second transistor is connected to the drain of the control transistor.

In the constant current circuit according to the second aspect, the constant current generation circuit is a current mirror circuit configured including the first transistor of the first conductivity type and having the gate and the drain connected together, the second transistor of the first conductivity type and having the gate connected to the gate of the first transistor and the source connected to the first resistor, and the third transistor of the second conductivity type having the drain connected to the drain of the first transistor. The control transistor is of the second conductivity type and has the gate and the drain connected together, and the drain of the second transistor is connected to the drain of the control transistor. Configuring a reference current of the constant current circuit using these four transistors enables the constant current circuit to have a simple configuration.

Constant current circuits according to a third aspect and a fourth aspect of the present disclosure further include a serial circuit includes a second resistor and a third resisitor connected to a drain of the control transistor. A drain of the bypass transistor is connected to a connection point between the second resistor and the third resistor.

The constant current circuits according to the third aspect and the fourth aspect further include the serial circuit includes the second resistor and the third resistor connected to the drain of the control transistor. The drain of the bypass transistor is connected to the connection point between the second resistor and the third resistor, thereby enabling current flowing into the control transistor to be reduced.

Aspects of the present disclosure exhibit an excellent advantageous effect of enabling a constant current circuit capable of improving the precision of an output current to be provided.

### BRIEF DESCRIPTION OF DRAWINGS

FIG. 1 is a circuit diagram illustrating an example of configuration of a constant current circuit according to an exemplary embodiment of the present disclosure;

FIG. 2A is a circuit diagram illustrating respective current paths in a constant current circuit according to an exemplary embodiment of the present disclosure;

FIG. 2B is a timing chart illustrating respective current states when starting a constant current circuit according to an exemplary embodiment of the present disclosure;

FIG. 2C is a timing chart illustrating respective current states when starting a constant current circuit according to an exemplary embodiment of the present disclosure;

FIG. 3A is a circuit diagram illustrating a constant current circuit according to related art; and

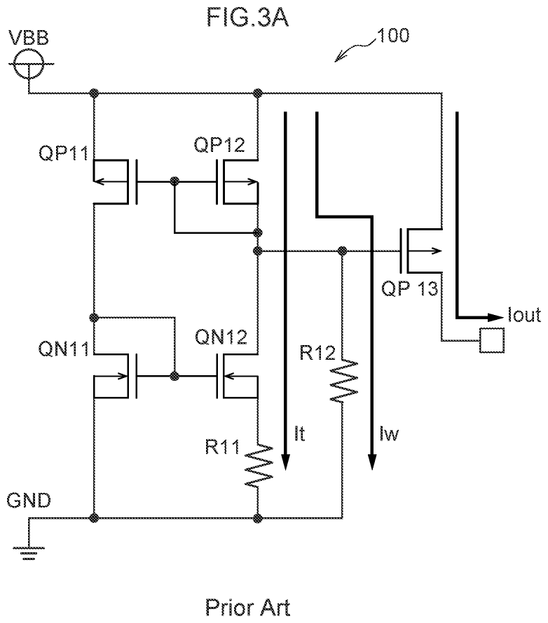

FIG. 3B is a graph illustrating respective current states when a power source is rising in a constant current circuit according to related art.

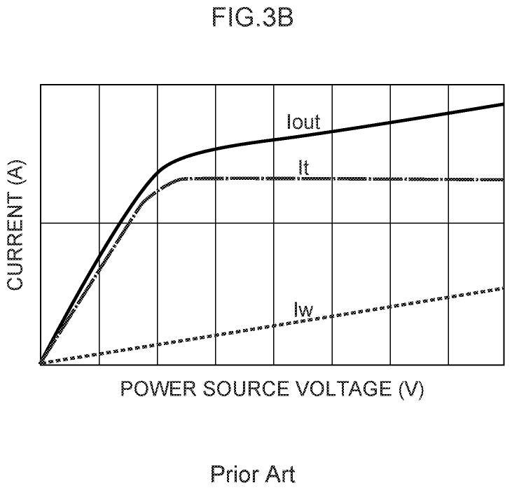

### DETAILED DESCRIPTION

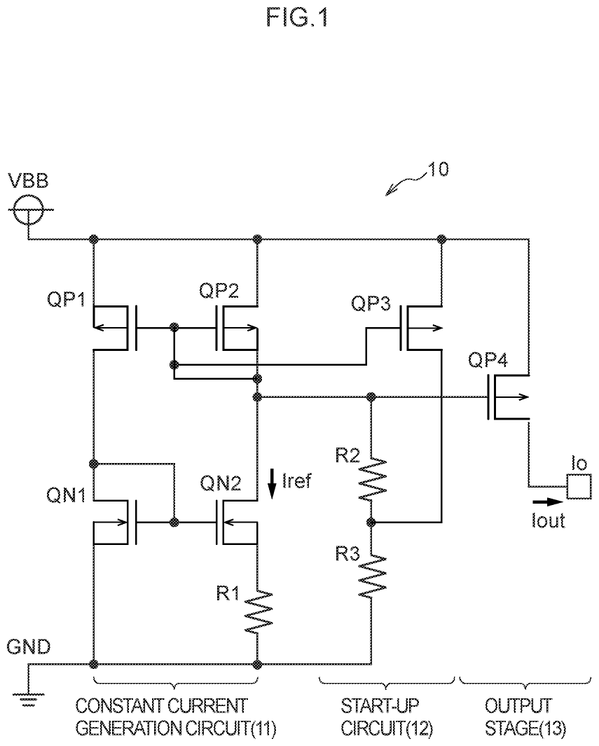

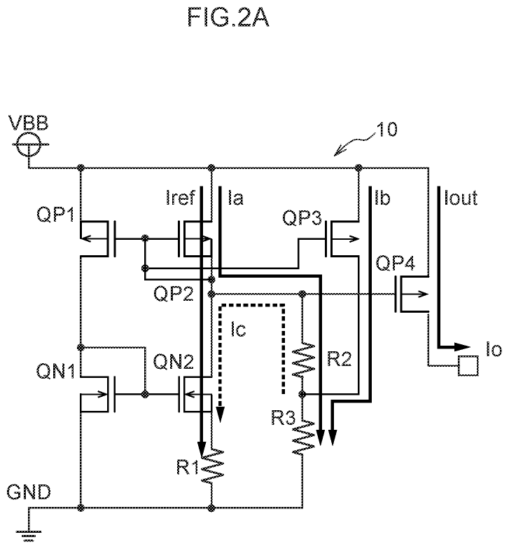

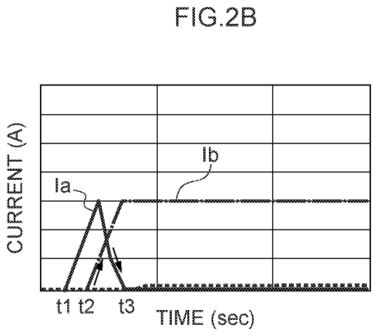

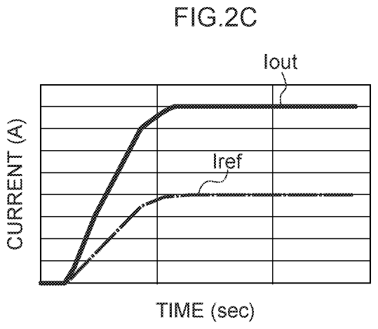

Explanation follows regarding a constant current circuit according to an exemplary embodiment of the present disclosure, with reference to FIG. 1 and FIG. 2.

FIG. 1 is a circuit diagram illustrating a constant current circuit 10 according to the present exemplary embodiment. As illustrated in FIG. 1, the constant current circuit 10 is configured including N-type MOS transistors QN1, QN2, P-type MOS transistors QP1, QP2, QP3, QP4, and resistors R1, R2, R3. As illustrated in FIG. 1, a constant current generation circuit 11 is configured including the N-type MOS transistors QN1, QN2, the P-type MOS transistors QP1, QP2, and the resistor R1. A start-up circuit 12 is configured including the P-type MOS transistor QP3 and the resistors R2, R3. An output stage 13 is configured including the P-type MOS transistor QP4. Note that the P-type MOS transistor QP2 is an example of a control transistor according to the present disclosure, the P-type MOS transistor QP4 is an example of an output transistor according to the present disclosure, and the P-type MOS transistor QP3 is an example of a bypass transistor according to the present disclosure.

The constant current generation circuit 11 is a current mirror circuit configured including the N-type MOS transistors QN1, QN2, and the P-type MOS transistors QP1, QP2. The constant current generation circuit 11 generates a reference current Iref as a current forming a source of an output current Iout output from an output terminal Io. The reference current Iref is a constant current with a current value defined by the transistor sizes of the N-type MOS transistors QN1, QN2 and the P-type MOS transistors QP1, QP2, and the resistance value of the resistor R1. The output current Iout is a current mirroring the reference current Iref at a prescribed mirror ratio. Although there is no particular limitation to the mirror ratio, in the present exemplary embodiment the mirror ratio is set at 1:1. The output stage 13 supplies the output current Iout to an externally connected load for example.

The start-up circuit 12 is configured including the P-type MOS transistor QP3 and the resistors R2, R3. The P-type MOS transistor QP3 has a gate with common connection to a gate of the P-type MOS transistor QP2. The start-up circuit 12 is a circuit in which a start-up current flows when the constant current circuit 10 is started up, for example when a power source VBB is switched on. After the power source VBB has been started up (for example when the voltage of the power source VBB attains a prescribed voltage value and thereafter) the current flowing in the P-type MOS transistor QP2 is caused to bypass. Conversely, since the P-type MOS transistor QP3 does not actuate until the power source has been switched on and the start-up current flows, the P-type MOS transistor QP3 does not impede usual start-up operation. The start-up circuit 12 will be described in detail later. Explanation follows regarding switching on the power source as an example of starting up the constant current circuit 10.

Note that the current value of the reference current Iref when the constant current circuit 10 is stable is in principle either of two values, namely zero or Iref. A current value of zero corresponds to a state in which there is no current flow (a non-actuated state), and for calculation purposes this is also considered stable. Accordingly, in the constant current circuit 10, a start-up circuit that causes a start-up current to flow initially is required in order to obtain a current value when stable of the reference current Iref (in order to actuate the constant current circuit 10). Moreover, there is a need for the output current Tout, this being the desired constant current, not to be dependent on the power source voltage of the power source VBB. The start-up circuit 12 is thereby employed in the constant current circuit 10.

Explanation follows regarding operation of the constant current circuit 10, with reference to FIGS. 2. FIG. 2A illustrates current flowing after the power source VBB is switched on (after starting the constant current circuit 10). FIG. 2B and FIG. 2C are timing charts illustrating respective currents when the power source is powered up (after starting up the constant current circuit 10). The reference current Iref is the current acting as the mirror source of the output current Tout, and is mirrored by the P-type MOS transistor QP4 to give rise to the output current Tout. Note that although in the present exemplary embodiment the mirror ratio at which this is performed is set to 1:1, there is obviously no limit to a mirror ratio of 1:1, and the mirror ratio may be set as appropriate according to the characteristics and so on demanded of the constant current circuit 10.

As illustrated in FIG. 2B, when the power source VBB is switched on at a timing t1, a start-up current Ia starts to flow from the P-type MOS transistor QP2 through the resistors R2, R3. The start-up current Ia is a current used to start up the constant current circuit 10. The balance of the constant current circuit 10 is upset by the start-up current Ia, such that the reference current Iref starts to flow accompanying the start of flow of the start-up current Ia as illustrated in FIG. 2C. At this point, a current obtained by mirroring of (Iref+Ia) starts to flow as the output current Tout.

Then, a bypass current Ib flows through the P-type MOS transistor QP3 and the resistor R3 at a timing t2. The bypass current Ib is a mirror current of the reference current Iref, and increases accompanying the start of flow of the reference current Iref so as to supply a current equivalent to the start-up current Ia. Namely, although the bypass current Ib is a current that accompanies start-up of the constant current circuit 10, the bypass current Ib does not flow in the P-type MOS transistor QP2. Namely, a current that flows in the P-type MOS transistor QP12 via the resistor R12 in the constant current circuit 100 according to the related art instead flows in the P-type MOS transistor QP3 in the constant current circuit 10 according to the present exemplary embodiment.

Accordingly, the start-up current Ia (namely the start-up current flowing in the P-type MOS transistor QP2) gradually decreases from the timing t2 onward, and in its place the bypass current Ib gradually increases. Since the start-up current Ia ceases to flow when a sufficient bypass current Ib is flowing, at a timing t3 the start-up current Ia and the bypass current Ib have switched over, and the bypass current Ib attains a constant value thereafter. As illustrated in FIG. 2C, while this happens, the reference current Iref gradually increases before attaining a constant value, and the output current Tout also tracks the reference current Iref and attains a constant value.

As described above, in the constant current circuit 10, after a prescribed duration has elapsed after switching on the power source VBB, the start-up current Ia which accompanies start-up ceases to flow in the P-type MOS transistor QP2, this being the source of the reference current Iref generation, thereby suppressing the dependency of the output current Tout on the power source voltage. Namely, in the constant current circuit 10, after the start-up current Ia has started to flow and the constant current circuit 10 has started up, the start-up current Ia flows as the bypass current Ib through a line that is unconnected with the output current Tout. This thereby enables the precision of the output current Tout to be improved.

A current that might flow into the constant current generation circuit 11 from the start-up circuit 12 (referred to hereafter as a flow-in current) will now be considered. In the constant current circuit 10, a current Ic that flows through the resistor R2, the N-type MOS transistor QN2, and the resistor R1 in this direction might flow as a flow-in current. The flow-in current Ic can be derived using Equation (1) below.

Ic=((VBB−Vds)−(VBB−Vgs))/R2 Equation (1)

VBB being the voltage of the power source VBB, Vds being the voltage between the drain and the source of the P-type MOS transistor QP3, Vgs being the voltage between the gate and the source of the P-type MOS transistor QP2, and R2 being the resistance value of the resistor R2.

Due to the characteristics of MOS transistors, it will generally be the case that Vds≈0, Vgs≈Vt.

Vt is a threshold voltage of the P-type MOS transistor QP2, and is generally a value of around 1V.

Due to the above, Equation (1) can be approximated to (1/R2). This (1/R2) may be set to a value significantly smaller than the start-up current Iw of the constant current circuit 100 according to the related art. Moreover, this current does not flow directly in the P-type MOS transistor QP2 that configures the mirror source. Any effects of flow-in current on the constant current circuit 10 can accordingly be ignored.

1. A constant current circuit comprising:
a constant current generation circuit;
a control transistor included in the constant current generation circuit and configured to allow a constant current generated by the constant current generation circuit and a start-up current at start-up to flow;
an output transistor having a gate voltage controlled by the control transistor and configured to generate an output current based on the constant current; and
a bypass transistor having a gate with common connection to a gate of the control transistor and configured to cause the start-up current flowing in the control transistor to bypass after start-up.

2. The constant current circuit of claim 1, wherein:
the constant current generation circuit is a current mirror circuit configured including:
a first transistor of a first conductivity type and having a gate and a drain connected together,
a second transistor of the first conductivity type and having a gate connected to the gate of the first transistor and a source connected to a first resistor, and
a third transistor of a second conductivity type having a drain connected to the drain of the first transistor;
the control transistor is of the second conductivity type and has a gate and a drain connected together; and
a drain of the second transistor is connected to the drain of the control transistor.

3. The constant current circuit of claim 1, further comprising:
a serial circuit includes a second resistor and a third resistor connected to a drain of the control transistor,
wherein a drain of the bypass transistor is connected to a connection point between the second resistor and the third resistor.

4. The constant current circuit of claim 2, further comprising:
a serial circuit includes a second resistor and a third resistor connected to a drain of the control transistor,
wherein a drain of the bypass transistor is connected to a connection point between the second resistor and the third resistor.
